(19) United States
(12) Patent Application Publication
(10) Pub. No.: US 2005/0197114 A1
(43) Pub. Date: Sep. 8, 2005

(54) Cellular communications systems

(76) Inventor: Burton K. Kent, Evanston, IL (US)

Correspondence Address: Law Office of Peter V.D. Wilde, 301 East Landing, Williamsburg, VA, 23185, US

(21) Appl. No.: 10/794,555

(22) Filed: Mar. 5, 2004

(51) Int. Cl. H04H 1/00

(52) U.S. Cl. 455/423

(57) ABSTRACT

The specification describes techniques for identifying blind spots in a cellular landscape using cellular call traffic analysis. It is based on the recognition that blind spots cause an inordinate number of failed connections. These are calls that either fail to set-up, or are terminated prematurely. Analyzing the call pattern over the area served by a station, and comparing that pattern to a previous pattern, can identify locations of abnormal or unusual changes in call patterns, such as call volume, call duration, etc. These variations will often indicate a blind spot within the network.

### FIELD OF THE INVENTION

This invention relates to cellular communication systems with improved wide area signal coverage.

### BACKGROUND OF THE INVENTION

A persistent problem with wireless communications is the wide variation in signal strength over an intended coverage area. Natural geographic features, as well as man-made structures, create “blind spots” where signal strength is inadequate. Changes in the physical environment, for example, when new structures are built, present an additional variable. The environment that produces blind spots for cellular users is referred to below as the cellular landscape. This includes any factor that affects signal strength for cellular traffic.

In an effort to provide seamless coverage, communications providers are constantly searching the cellular landscape for blind spots. Search tools are mainly empirical, using monitoring stations, either fixed or mobile. Customer feed-back is also used. It is especially difficult to compensate for dynamic changes.

To date, identifying blind spots is mainly based on conventional trouble reports. Effectively locating and verifying a blind spot is thus slow, and often not reliable.

More sophisticated methods for dealing with blind spots have been developed for ultra-high reliability applications used by government and military personnel. A known way of compensating for blind spots is to operate with some geographic redundancy in the coverage area, and switch calls that have inadequate signals to other base stations. Another approach is to relay calls to other existing towers in the network until a tower having adequate signal strength is identified. Obviously, these solutions add cost to the wireless network. Moreover, even if the system is designed to allow the affected traffic to be re-routed, congestion may result. That is because a typical network is built with a predetermined traffic pattern and capacity. If blind spots cause significant re-routing of traffic, the links chosen for the new traffic may overload.

In summary, it would be desirable to have a technique that can locate blind spots quickly, and can identify dynamic changes in effective coverage area. This allows for structural and orderly planned network solutions.

### BRIEF STATEMENT OF THE INVENTION

According to the invention, a technique has been developed that identifies blind spots in a cellular landscape using cellular call traffic analysis. It is based on the recognition that blind spots cause an inordinate number of failed connections. These are calls that either fail to set-up, or are terminated prematurely. Analyzing call patterns over the area served by a station, and comparing that pattern to a previous pattern, allows identification of locations of abnormal or unusual changes in call traffic, for example, unusual changes in call volume or call duration. In many cases this can be achieved with no added network cost or complexity since the data used for the analysis is already collected by the network system.

When this technique is applied to customers that are moving, e.g. customers using the wireless service from a moving vehicle, the technique allows these customers to act as a team of monitors for the entire cell area.

### BRIEF DESCRIPTION OF THE DRAWING

The invention may be better understood when considered in conjunction with the drawing in which:

FIG. 1 is a schematic diagram of a wireless cell in an ENS telephone network;

FIG. 2 is a schematic representation of ring patterns useful in the system of FIG. 1;

FIG. 3 is a circuit diagram of a ring pattern detector (RPD).

### DETAILED DESCRIPTION OF THE INVENTION

Telephone communication users can be divided into two groups, land-based users and cell phone users. In this context a land-based user either originates or receives a call on a land-line. A cell phone user either originates or receives a call on a wireless cellular phone. The land-based user may use a wireless station set but, for purposes described here, is still a land-based user. Since the invention described here addresses problems with cellular systems, the land-based users may be disregarded. However, it is to be understood that the call traffic analysis used in the method of the invention may, and typically will, involve calls involving one land-based party.

The most useful data for the traffic analysis described here involves cellular users only. Traffic data involving at least one cellular user is analyzed periodically to reveal anomalous patterns. These patterns signal potential blind spots.

There are several embodiments of the invention based on this premise. An especially reliable and useful embodiment is detecting changes in the cellular landscape. This may be achieved using one or more of the analyses described below in connection with FIGS. 1-?.

With reference to FIG. 1, an illustrative call traffic pattern is shown. The data are synthetic for the purpose of the illustration. However, the data is representative of typical call patterns. The traffic shown represents traffic from a single cellular tower. Thus the data will be restricted to only calls involving at least one cellular user. Other methods for separating cellular call data from land-line data may be used.

FIG. 1 shows a traffic pattern generated by monitoring call volume over time. The time scale shown here is measured in weeks, however, the analysis may focus on daily volume, or even hourly volume. In any case, a baseline template is generated that represents a normal or baseline traffic pattern. FIG. 1 shows a baseline template for a selected cellular relay tower. It shows normal or expected traffic over a normal 12 week period. A normal range for this cell tower and this cellular landscape falls between boundary lines 21 and 22.

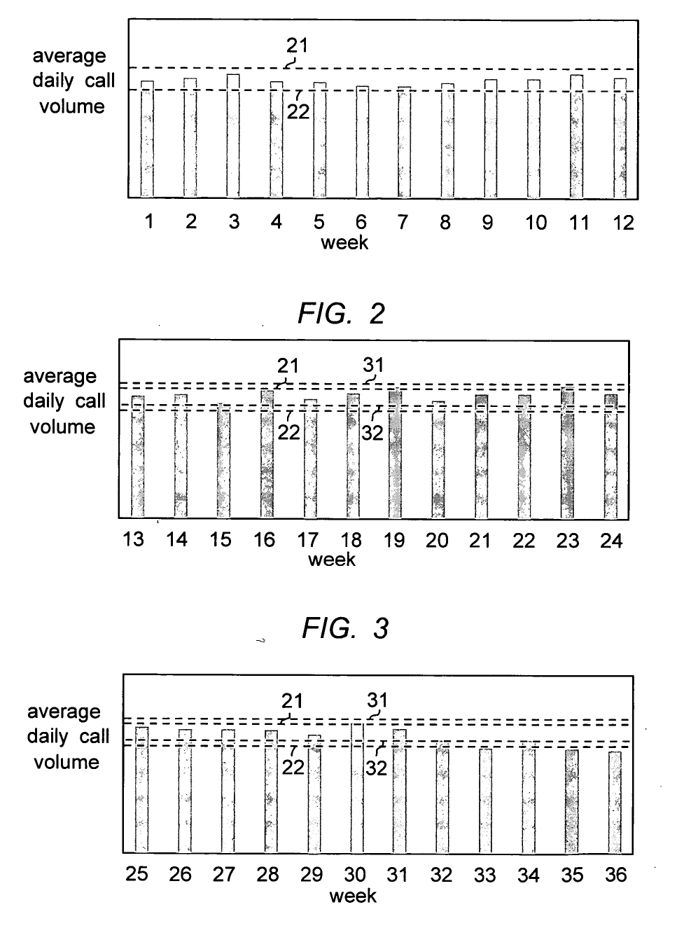

FIG. 2 shows a similar analysis for traffic for weeks 13-24. Here the traffic shows a steady increase in volume. That departure from the baseline suggests increased customer demand for the service. This kind of analysis is routinely performed, and these kinds of results routinely used, to upgrade network performance and capacity. In FIG. 2, the boundaries for normal call volume have been adjusted to 31 and 32.

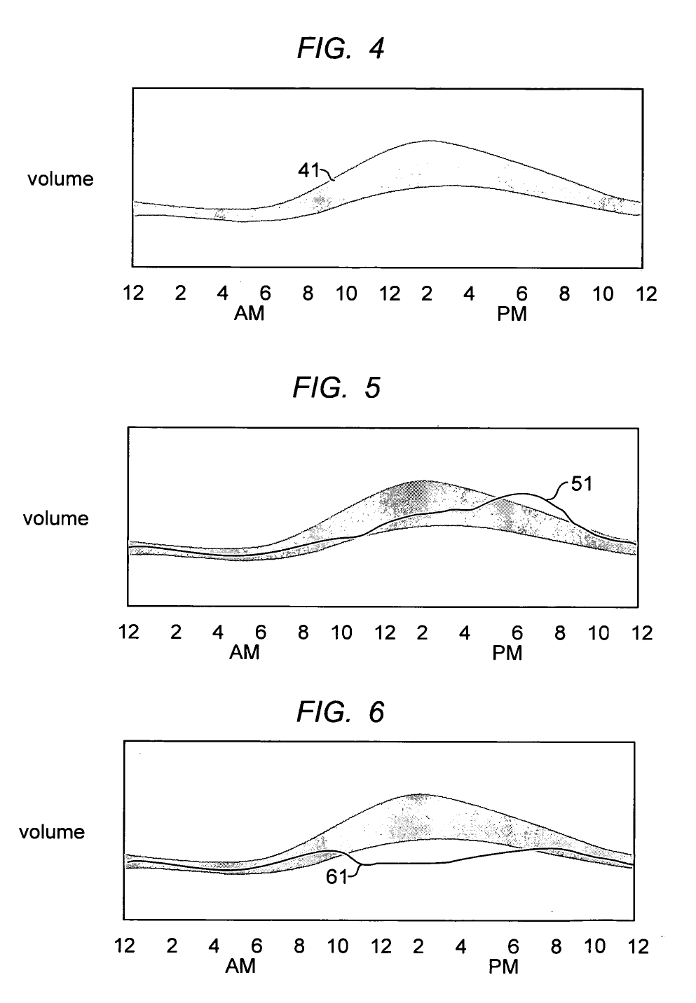

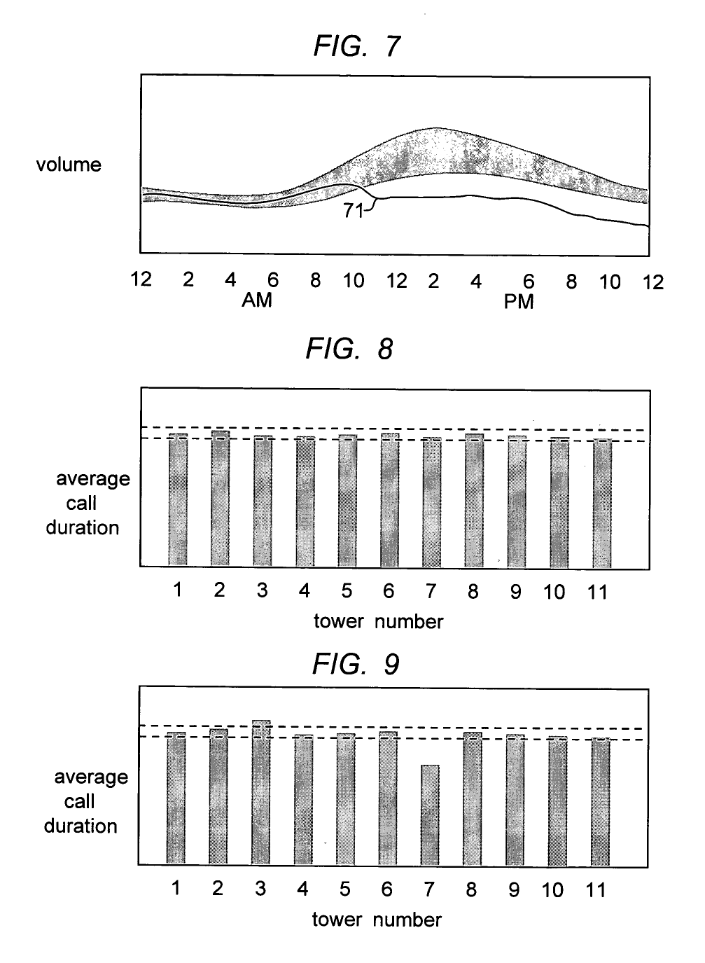

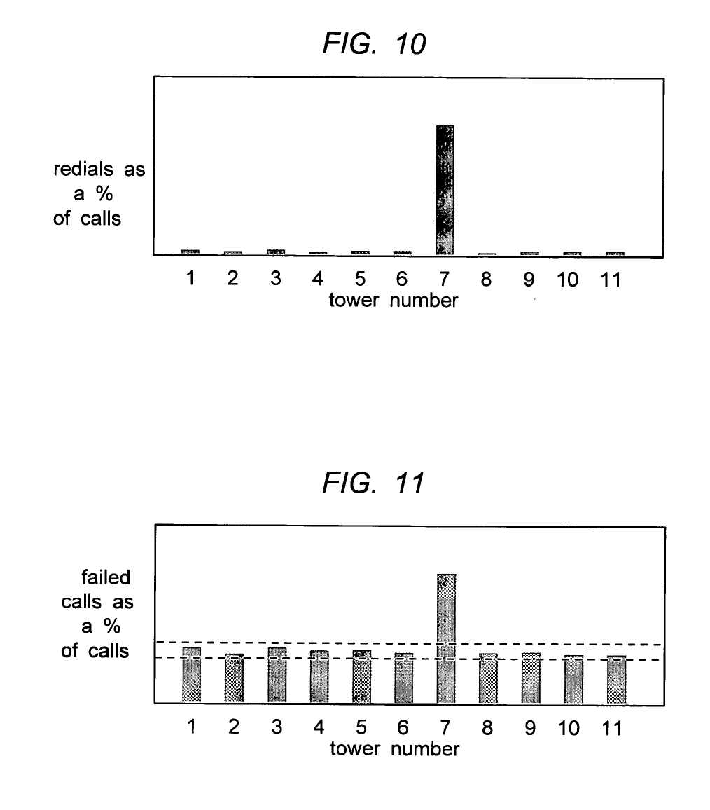

FIG. 3 illustrates a different kind of anomaly. Here the call volume is shown as declining beginning at week 31, and falling below the nominal baseline in week 33. The continued decline signals a change in the landscape that has created a blind spot.

Having an early warning that a blind spot is developing, or has developed, the system engineer may then use conventional tracking methods to pinpoint the location. There are several options for doing this. Most typically, mobile units of the cellular service provider traverse the landscape and measure signal power. Thus the blind spot is identified using network management equipment and personnel. However, a preferred method, according to the invention, is to identify callers in the suspect landscape that are moving and track those callers until the call is terminated. The locations where the calls are terminated are mapped. If the suspected blind spot exists, a cluster will be revealed at the physical location of the blind spot. Remediation may take any suitable form. If the landscape change involves a building, then a suitable response may be relocating the tower, or adding another tower. Techniques for locating moving callers, and tracking them, are well known. An example of such a method is triangulation, where two tracking stations, or moving vehicles, lock onto the radio signal of the cell phone user. The position of the user is obtained and tracked using simple trigonometric algorithms.

The analysis presented here is rudimentary to illustrate how traffic data may be used to locate cellular blind spots in the cellular landscape. Actual system data, data analysis, and cell user location, will be substantially more complex and sophisticated.

In the example just described this type of landscape change occurs over a relatively long period, and the traffic pattern changes slowly, and monotonically. The example is chosen for convenience as one that is simple to illustrate. However, blind spots have other common causes, for example, interference from other radio signals in the cellular landscape. These blind spots may develop instantly. To effectively identify these requires monitoring on a shorter time scale, and a somewhat more sophisticated analysis. To further complicate this analysis, the source of these blind spots may be intermittent.

FIG. 4 shows a traffic pattern on an hourly time scale. The volume scale is compressed for convenience. Typical volume swings on an hourly scale are large. The normal traffic pattern, represented by envelope 41, has a high-low range as shown, and is generated using data over at least several days. The range typically shows a higher variation at peak usage. It is preferred that the data used to generate the baseline envelope is dynamic, so slowly varying changes and monotonic changes can be transparent. The focus here is on identifying rapidly developing, changes over a relatively short term. Obviously, while the time scale illustrated here is hourly, shorter or longer scales may be used. It is preferred that the baseline data be gathered during a trouble-free period of cell phone usage, i.e. a period low user complaints of unwanted call termination. That helps establish a normal baseline envelope.

With a baseline established, significant departures from normal traffic are easily revealed. FIG. 5 shows a separate curve 51 representing daily traffic usage for a 24 hour period. It is overlaid over the baseline envelope to identify potential anomalies. An anomaly is shown at 53, and represents an upward spike in call volume. Upward spikes may be largely disregarded in identifying potential blind spots. FIG. 6 shows a potentially relevant anomaly at 61. That anomaly is a transient anomaly since the volume returns to normal over the period shown. However, subsequent daily data needs to be examined to determine if that anomaly is repeated. Repetition would indicate a potential blind spot that occurs in that time slot. Suitable remediation would be to re-route traffic during that time slot. The location of the blind spot may be identified using the methods described earlier. With the benefit of that information, more permanent remediation may be arranged. However, it should be understood that the method of the invention is useful for signaling the presence or onset of a blind spot in a given cell landscape. Finding the precise location of the blind spot is a further element of the invention.

FIG. 7 shows an anomaly at 71 that, on this time scale appears to be potentially permanent. That anomaly may be tracked over subsequent time periods to verify the permanent nature of the blind spot. Blind spots that develop instantly, like that shown in FIG. 7, can be verified in a relatively short time period. This compares favorably with a blind spot that grow gradually, i.e. the one illustrated in FIGS. 1-3.

Another illustration of using call traffic information to locate potential or actual cellular blind spots will be described in conjunction with FIGS. 8 and 9. In this embodiment, an anomaly in call duration is the basis for the analysis. The premise is that the onset of a pattern of short call duration will result from calls that are prematurely terminated. A pattern of premature call termination is likely to signal a blind spot.

FIG. 8 shows a pattern of normal call duration, with call duration in time plotted over a time scale. Data is given for several different cellular towers. FIG. 9 shows a departure from the normal baseline duration for tower 3. This shows a call duration increase, and does not suggest a network defect. However, tower 7 shows a significant decrease in average call duration. This signals a potential blind spot in the landscape served by tower 7.

FIG. 10 shows data for redials recorded for towers 1-11 over the same time period used to record the data of FIG. 9. Redials are calls where the same number is dialed in succession. These are easily revealed and tracked by network software. While some redials may represent normal call behavior, if calls are terminated prematurely, it is highly likely that one or more attempts may be made by the caller to re-establish the connection. That would be revealed by a re-dial. A significant increase in redials, over a baseline average, would signal this event. Tower 7 has a large increase in redials, confirming the problem revealed by the data of FIG. 9. Redial data may be especially significant by itself. It is a direct and instant indication of a network problem. When the redial data is localized, as shown in FIG. 10, a cellular landscape problem is a likely cause.

Similarly revealing are failed calls, i.e. calls that fail to set-up. FIG. 11 shows call set-up failures as a percent of calls, again plotted geographically using data from separate towers. Here again, tower number 7 shows a network malfunction identified in geographical terms.

An important aspect of the invention is in understanding the value of the data in the context of locating and remedying blind spots in the cellular landscape. Data like that described in connection with FIGS. 1-11 is routinely collected by network OA&M (Operations, Administration and Maintenence) systems. Accordingly, it is important to analyze the data with a methodology that reveals blind spot defects in the cellular landscape. That methodology begins with separating data for cellular calls from land-line calls. The separation may involve simply suitably selecting the data source. For example, data from cellular system towers is inherently separating in this context. As described above, it also is intrinsically sorted by geography. For some embodiments of the invention, it is useful to separate moving cellular calls from stationary cellular calls. The most helpful kind of data, for the purposes of the invention, is data from a cellular call that terminates while the caller is moving. That provides the most likely source of calls terminated as a result of blind spots. Moreover, it allows the system of the invention to pinpoint the landscape location where the failure(s) occurred.

Modifications of the network, cell base stations, cell phones etc. may allow the user to signal when a call is terminated intentionally vs. a call that is dropped prematurely due to a failure in the system. A relatively simple implementation of this is to have the handset signal a hang-up. The system can then distinguish between calls that are deliberately terminated vs. a call that is dropped prematurely due to a failure in the system. This feature enables a simpler and more reliable analysis and detection of blind spots, still using the basic teachings of the invention.

The invention therefore is defined by steps, in addition to data collection, that allow repair, reconstruction, or modification, of the cellular network in response to an analysis of the data. The term “remedying”, or the phrase “performing a remedial step”, refers to any action taken by a network engineering, administrative, or other faculty, in response to a data analysis of the kind described above, to reduce or change the effect of one or more blind spots in the cellular landscape.

The term traffic pattern data used herein refers to call data of the type represented by FIGS. 1-11, and includes, but is not limited to, call volume, call duration, call set-up failures, redials.

Various additional modifications of this invention will occur to those skilled in the art. All deviations from the specific teachings of this specification that basically rely on the principles and their equivalents through which the art has been advanced are properly considered within the scope of the invention as described and claimed.

1. A method for managing a cellular network comprising the steps of:
a. collecting cellular traffic pattern data,
b. identifying an anomaly in the cellular traffic pattern,
c. using the cellular traffic pattern, identifying the geographic location of the anomaly,
d. in response to steps a-c, performing a remedial step to the network.

2. The method of claim 1 wherein the cellular traffic pattern data is call volume data.

3. The method of claim 1 wherein the cellular traffic pattern data is call duration data.

4. The method of claim 1 wherein the cellular traffic pattern data is call redial data.

5. The method of claim 1 wherein moving cellular call users are tracked to identify the location of call terminations.

6. The method of claim 1 wherein the cellular traffic pattern data is used to establish a baseline for a normal cellular traffic pattern, and additional cellular traffic pattern data is compared with the baseline to identify the anomaly.

7. The method of claim 1 wherein the remedial step comprises rerouting call traffic.
